(19) United States
(12) Patent Application Publication
(10) Pub. No.: US 2012/0086709 A1
(43) Pub. Date: Apr. 12, 2012

(54) 3D/2D DISPLAY DEVICE SWITCHING MODULE

(75) Inventors: YU-CHOU YEH, TAOYUAN COUNTY (TW); CHAO-YI WANG, TAOYUAN COUNTY (TW); WEN-CHIH LO, TAOYUAN COUNTY (TW); TSUNG-HER YEH, TAIPEI COUNTY (TW)

(73) Assignee: J TOUCH CORPORATION, TAOYUAN COUNTY (TW)

(21) Appl. No.: 13/040,442

(22) Filed: Mar. 4, 2011

(30) Foreign Application Priority Data
Oct. 8, 2010 (TW) 099134362

(51) Int. Cl. G06T 15/00

(52) U.S. Cl. 345/419

(57) ABSTRACT

A 3D/2D display device switching module installed to the front side of a display device includes a first axle and a second axle installed on both sides of the display device respectively, and a thin film unit looped between the two axles. The first axle is coupled to a first power source. The thin film unit has a transparent area and at least one grating area. After the first power source drives the first axle to rotate clockwise or counterclockwise, the transparent area or the grating area is switched to align with the display device to produce a 3D/2D display effect. In addition, the present invention further includes a containing box installed at the backside of the display device for stacking and accommodating the thin film unit with more different types of grating areas.

### CROSS-REFERENCE TO RELATED APPLICATIONS

This non-provisional application claims priority under 35 U.S.C. §119(a) on Patent Application No(s). 099134362 filed in Taiwan, R.O.C. on Oct. 8, 2010, the entire contents of which are hereby incorporated by reference.

### BACKGROUND OF THE INVENTION

1. Field of the Invention

The present invention relates to the field of 3D/2D display devices, and more particularly to a 3D/2D display device switching module that uses a single/dual power source to drive a thin film unit to have a quick and diversified way of switching a display mode.

2. Description of the Prior Art

At present, most 3D imaging systems adopt the parallax method, such that the 3D imaging system will create video information of two images which are called a “stereo pair”, and our left eye can see the left image only, and our right eye can see the right image only. When the two video images are played synchronously, our eyes can see the video information of the two video images from two different angles respectively, particularly when there is a slight difference between shadows or scene profiles of the two video information, and our brain receives and processes the information to produce an accurate 3D object, and the positioning of the 3D object in a scene will produce a 3D feel with a depth of field,

At present, some manufacturers have designed a liquid crystal display capable of switching its display to a 3D/2D mode and using a parallax barrier to accurately guide the light of the original 2D video information to a viewer's left and right eyes to produce an analog parallax, so as to achieve the effect of switching the display to a 3D display mode without using a pair of special glasses to view the 3D image. With reference to FIG. 1 for a schematic view showing the principle of a conventional liquid crystal display capable of switching 3D and 2D displays, the liquid crystal display 10 comprises a display panel 11, a switching liquid crystal 12 and a parallax barrier 13, wherein the parallax barrier 13 is installed at the front of the display panel 11, and the switching liquid crystal 12 is electrically coupled to the parallax barrier 13. When the liquid crystal display 10 displays 3D images, the switching liquid crystal 12 is turned on, so that the parallax barrier 13 divides the light propagation path into two, which are provided for focusing the left-eye and right-eye video information at a viewer's left and right eyes respectively. After the two video data are stacked, a 3D visual effect will be produced. If the switching liquid crystal 12 is turned off, then a shading portion of the parallax barrier 13 will become transparent, and the light propagation paths of the video information will become the same one and resume the original 2D planar display. However, the liquid crystal display 10 capable of quickly switching to a 3D/2D display mode has to use the expensive switching liquid crystal 12 and parallax barrier 13, and thus the manufacturing cost will be increased by 50% or more.

In view of the expensive components, some manufacturers proposed another type of 3D/2D switching display devices. With reference to FIG. 2 for a schematic perspective view of a structure of a conventional 3D/2D switching display device, the 3D/2D switching display device 20 comprises an image module 21, a thin film array device 22, a thin film driver 23 and a height control device 24, wherein the thin film array device 22 includes a totally transparent area 221 and a binary grating area 222, and the thin film driver 23 drives the thin film array device 22 disposed at the top of the image module 21 to rotate, and the thin film driver 23 is disposed on a lateral side of the image module 21, and the height control device 24 is provided for controlling a gap between the thin film array device 22 and the image module 21. The 3D/2D switching display device 20 uses the thin film driver 23 to drive the thin film array device 22 to rotate, such that the totally transparent area 221 and the binary grating area 222 on the thin film array device 22 can switch the image module 21, and the thin film array device 22 having the binary grating area 222 can achieve the shading function of the parallax barrier 13 to provide the effects of switching the 3D/2D display modes and lowering the manufacturing cost and the level of technical difficulty. However, the thin film array device 22 of such 3D/2D switching display device 20 only has the totally transparent area 221 and binary grating area 222, so that the grating must be arranged perpendicular to the lower edge of the screen to show the 3D grating effect with the depth of field. In some of the display devices or mobile communication devices which are easily available in the market and can be turned with a rotating angle, the design of the binary grating area 222 that can be rotated with an angle in a single direction cannot produce the effect with the depth of field, and the thin film array device 22, the thin film driver 23 and the height control device 24 cannot be turned together with the image module 21. Obviously, the conventional 3D/2D switching display device requires improvements.

In view of the shortcomings of the prior art, the present invention provides a novel 3D/2D display device switching module that uses a single/dual power source to cyclically drive a thin film unit having various types of grating areas, and quickly rotate the thin film unit to switch a 3D grating display effect corresponding to different viewing angles, together with an angular change of the 2D screen (such as an angular change from a perpendicular position to an aslant position, a perpendicular position to a horizontal position, a horizontal position to an aslant position, or a horizontal position to a perpendicular position). In addition, the 3D/2D display device switching module has larger containing box and tension adjusting structure to increase the space available for storing the thin film unit and assure that the rotated thin film unit is corresponsive to the surface flatness of the screen.

### SUMMARY OF THE INVENTION

Therefore, it is a primary objective of the present invention to provide a 3D/2D display device switching module that uses a single/dual power source to drive a thin film unit to rotate to achieve a quick way of switching a display mode.

A secondary objective of the present invention is to provide a containing box assembly used by the 3D/2D display device switching module and providing more spaces available to store the thin film unit and accommodate the thin film unit with more different types of grating areas and achieving a batter 3D grating effect.

Another objective of the present invention is to provide a tension adjusting structure used by the 3D/2D display device switching module for adjusting the tension when the thin film unit is driven to rotate, so as to assure that the thin film unit is corresponsive to the surface flatness of the screen.

To achieve the foregoing objectives, the present invention provides a 3D/2D display device switching module installed to a display device, for switching a display to a 3D/2D mode. The switching module comprises: a first axle, installed to a side of the display device; a second axle, installed to another side of the display device; a thin film unit, being a coiling structure looped between the first roller and the second roller, and having a transparent area and at least one grating area; and a first power source, coupled to the first axle, for driving the first axle to rotate, such that after the thin film unit is rotated, either the transparent area or the grating area is aligned with the front side of the display device to achieve a switching effect.

In a preferred embodiment, the 3D/2D display device switching module further comprises a second power source coupled to the second axle for driving the second axle to rotate, an that the first power source drives the first axle, and the second power source drives the second axle, for adjusting the tension of the thin film unit between the two axles, as well as driving the thin film unit to rotate in both directions to improve the switching efficiency.

In a preferred embodiment, the first power source and the second power source can be a step motor, an induction motor or a servo motor.

In a preferred embodiment, the 3D/2D display device switching module further includes a containing box installed at the backside of the display device, and the containing box includes at least two symmetric roller modules installed horizontally in the containing box and provided for stacking and winding the thin film unit between the roller modules, such that more spaces are available for storing the thin film unit and accommodating more different types of grating areas, so as to provide a better 3D grating effect.

In a preferred embodiment, the roller modules further includes a tension adjusting structure for adjusting the tension of the thin film unit when the thin film unit is rotated in the containing box to assure that the thin film unit is corresponsive to the surface flatness of the screen.

It is noteworthy to point out that the thin film unit has a plurality of grating areas, and each grating area is arranged in a different way. For example, the thin film unit comprises a grating area arranged perpendicularly with the first axle and the second axle, or the thin film unit comprises a grating area arranged horizontally with the first axle and the second axle, or the thin film unit comprises a grating area arranged slantingly with the first axle and the second axle. Together with the angular change of the 2D screen (such as an angular change from a perpendicular position to an aslant position, a perpendicular position to a horizontal position, a horizontal position to an aslant position, or a horizontal position to a perpendicular position), the present invention still can switch the grating area corresponding to different viewing angles by quickly rotating the thin film unit to achieve the 3D display effect.

### BRIEF DESCRIPTION OF THE DRAWINGS

FIG. 1 is a schematic view showing the principle of a conventional liquid crystal display capable of switching 3D and 2D displays;

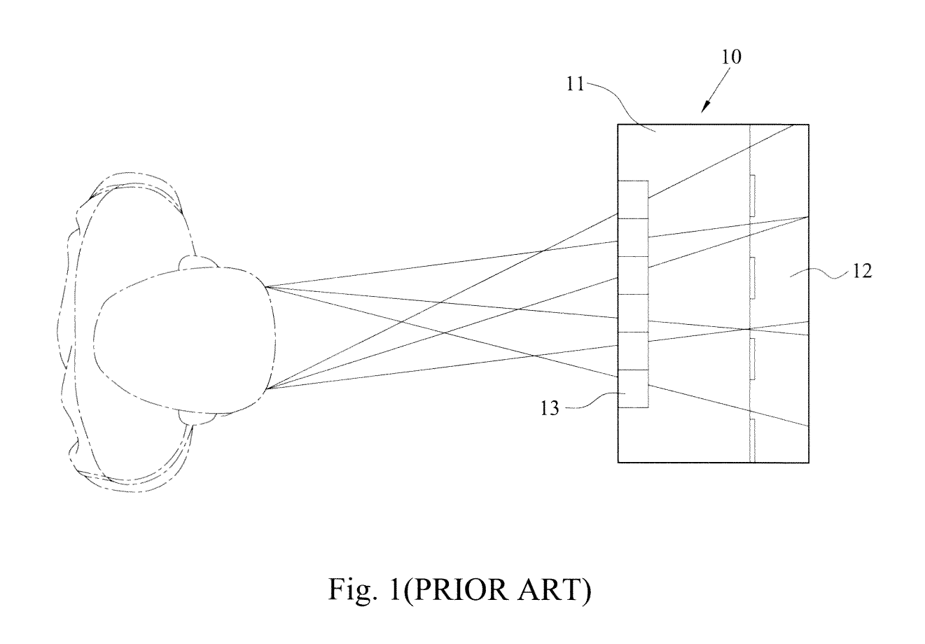

FIG. 2 is a schematic perspective view of a structure of a conventional 3D/2D switching display device;

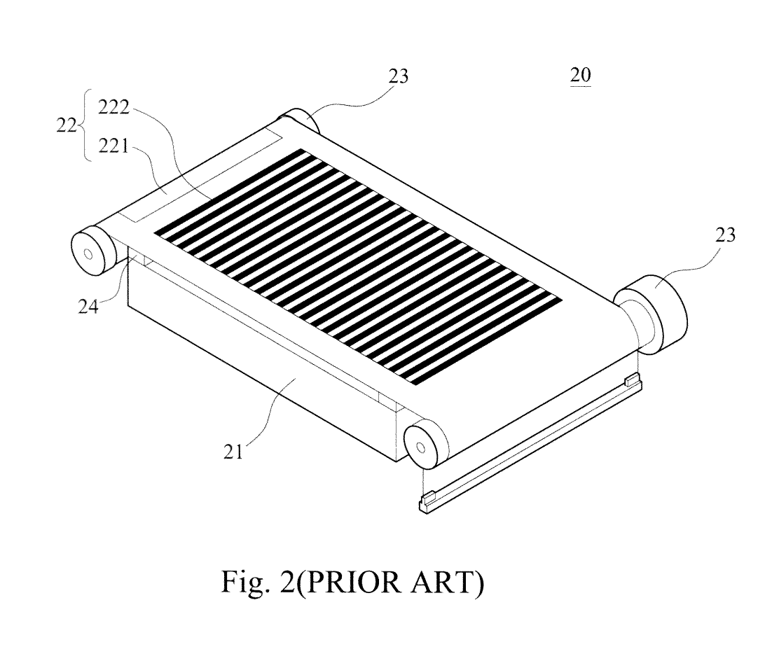

FIG. 3 is a schematic structural view of a preferred embodiment of the present invention;

FIG. 4 is a schematic view of an application of preferred embodiment of the present invention;

FIG. 5 is a schematic structural view of another preferred embodiment of the present invention;

FIG. 6 is a schematic view of an application of another preferred embodiment of the present invention; and

FIG. 7 is a schematic spread-open view of a thin film unit in accordance with another preferred embodiment of the present invention.

### DETAIL DESCRIPTION OF THE PREFERRED EMBODIMENTS

To make it easier for our examiner to understand the technical contents of the present invention, preferred embodiments together with related drawings are used for the detailed description of the present invention as follows.

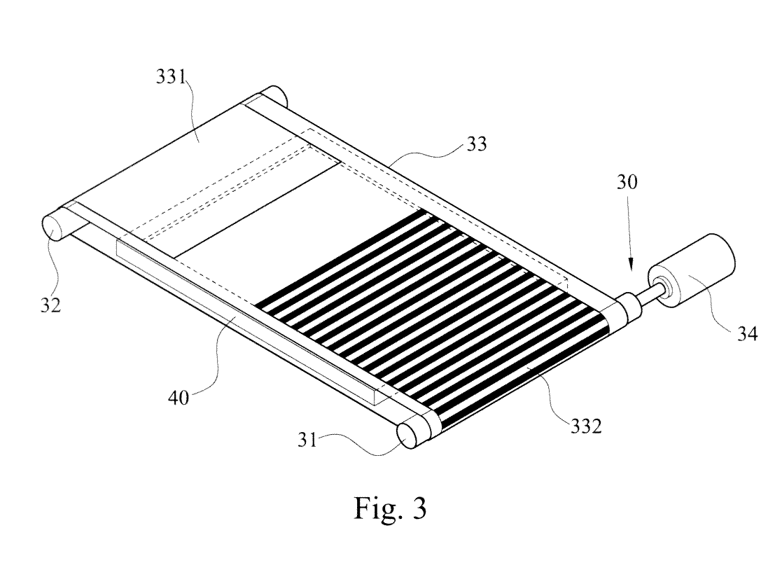

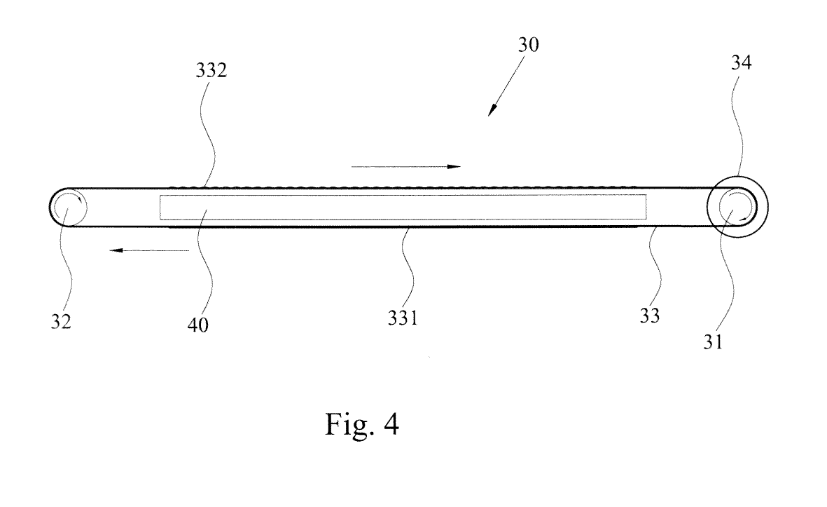

With reference to FIGS. 3 and 4 for a structural view of a 3D/2D display device switching module and a schematic view of an application in accordance with a preferred embodiment of the present invention respectively, the 3D/2D display device switching module 30 is installed to a display device 40 for switching a 3D/2D display mode, and the 3D/2D display device switching module 30 comprises a first axle 31, a second axle 32, a thin film unit 33 and a first power source 34.

The first axle 31 is installed on the right side of the display device 40, and the second axle 32 is installed on the left side of the display device 40, and the thin film unit 33 is substantially a coiling structure looped between the first roller 31 and the second roller 32, and the thin film unit 33 includes a transparent area 331 and a grating area 332, such that the transparent area 331 and the grating area 332 of the thin film unit 33 are disposed at the front side of a screen of the display device 40, and a predetermined gap is formed between the thin film unit 33 and the screen of the display device 40. The first power source 34 and the first axle 31 are coupled for driving the first axle 31 to rotate in a single direction, and thus the second axle 32 becomes a follower. A side of the thin film unit 33 is driven by the rotation of the first axle 31 to align either the transparent area 331 or the grating area 332 with the front side of the screen of the display device 40. If the transparent area 331 is aligned with the screen of the display device 40, then the original 2D screen will be displayed, and if the grating area 332 is aligned with the screen of the display device 40, then the grating area 332 will be used for producing the effect of a 3D display with a depth of field for the 2D screen. It is noteworthy to point out that the first power source 34 is a general step motor, induction motor or servo motor for accurately controlling the moving distance of the thin film unit 33. Therefore, the present invention can use the first power source 34 to drive the thin film unit 34 to rotate cyclically in a single direction to achieve the effect of switching a 3D/2D display.

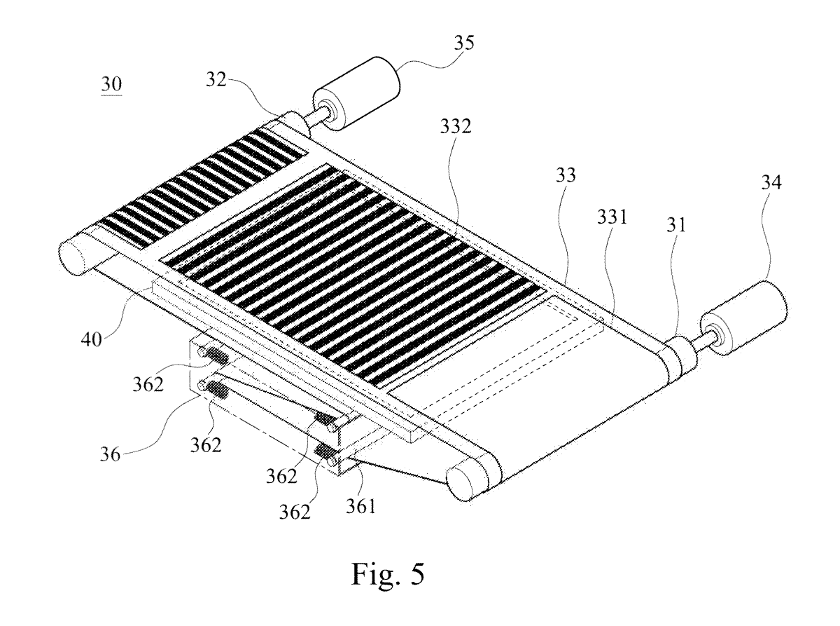

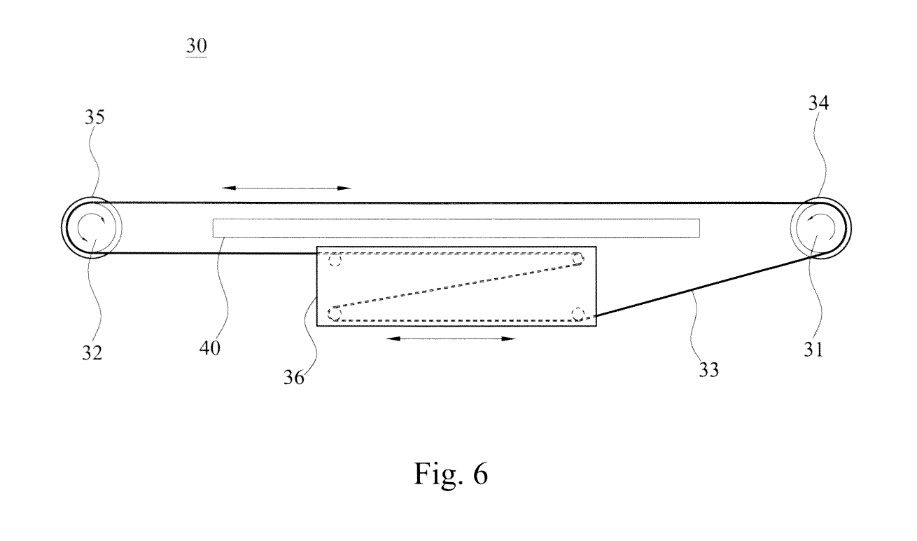

With reference to FIGS. 5 and 6 for a schematic structural view of a 3D/2D display device switching module and a schematic view of an application in accordance with another preferred embodiment of the present invention and provided for improving the using effect of the previous preferred embodiment, the 3D/2D display device switching module 30 with the aforementioned structure further comprises a second power source 35, which is a common step motor, induction motor or servo motor, and the second power source 35 and the second axle 32 are coupled for driving the second axle 32 to rotate, so that the first power source 34 can drive the first axle 31 to rotate, and the second power source 35 can drive the second axle 32 to rotate, in order to adjust the tension of the thin film unit 33 between the two axles 31, 32 as well as driving the thin film unit 33 to rotate in a direction or two directions to improve the switching effect.

In this preferred embodiment, a containing box 36 is installed at the backside of the display device 40, and the containing box 36 includes at least two symmetric roller modules 361 horizontally installed in the containing box 36 for stacking and winding the thin film unit 33 between the roller modules 361 in order to provide more spaces for storing the thin film unit 33, accommodating the thin film unit 33 with more different types of grating areas 332, and achieving a better 3D grating effect. It is noteworthy to point out that the roller modules 361 further includes a tension adjusting structure 362 for adjusting the tension of the thin film unit 33 when it is rotated in the containing box 36 to assure that the thin film unit 33 is corresponsive to the surface flatness of the screen.

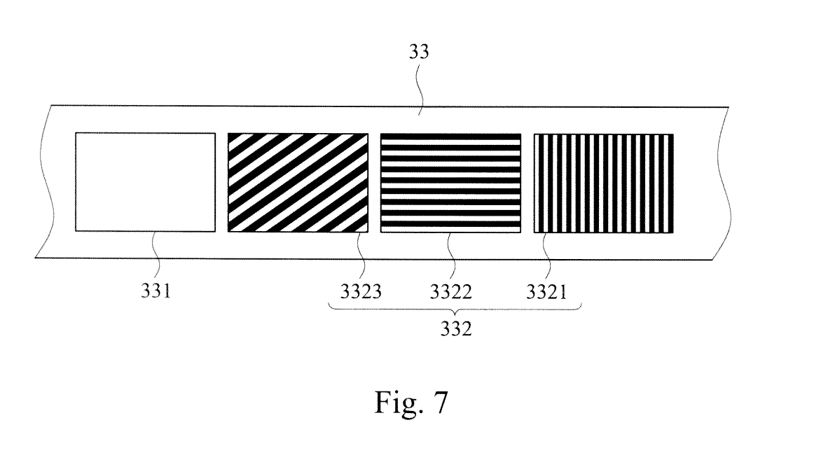

With reference to FIG. 7 for a schematic spread-open view of a thin film unit in accordance with another preferred embodiment of the present invention and FIG. 5, the thin film unit 33 includes a plurality of grating areas 332 and a transparent area 331, and each grating area 332 is arranged in a different way, and the grating areas 332 sequentially include a first grating area 3321, arranged horizontally with respect to the first axle 31 and the second axle 32; a second grating area 3322, arranged perpendicularly with respect to the first axle 31 and the second axle 32; and a third grating area 3323, arranged slantingly with respect to the first axle 31 and the second axle 32. The 3D screen of the display device 40 can change its angle. For example, the 3D screen is arranged horizontally when the first grating area 3321 is used, the 3D screen is arranged vertically when second grating area 3322 is used, and the 3D screen is arranged slantingly when the third grating area 3323 is used. It is noteworthy to point out that display devices installed in mobile communication devices and portable electronic devices include a gyroscope for detecting the direction of these devices to change displaying direction of the screen automatically, so that the present invention can be applied to the mobile communication devices or portable electronic devices for providing the effect of switching to a 3D/2D mode for different viewing angles.

However, the preferred embodiments are provided for the purpose of illustrating the present invention only, but not intended for limiting the scope of the present invention. For example, the material and length of the thin film unit, the distance of the thin film unit from the display device, the installing positions or models of the first power source and/or the second power source, or the material, dimensions or installing position of the containing box can be modified, but such modification is included the scope of the present invention. While the invention has been described by means of specific embodiments, numerous modifications and variations could be made thereto by those generally skilled in the art without departing from the scope and spirit of the invention set forth in the claims.

What is claimed is:

1. An 3D/2D display device switching module, installed to a display device, for switching a display to a 3D/2D mode, and the switching module comprising:
a first axle, disposed to a side of the display device;
a second axle, disposed to another side of the display device;
a thin film unit, being a coiling structure looped between the first roller and the second roller, and having a transparent area and at least one grating area; and
a first power source, coupled to the first axle, for driving the first axle to rotate, such that after the thin film unit is rotated, either the transparent area or the grating area is aligned with the front side of the display device to achieve a switching effect.

2. The 3D/2D display device switching module of claim 1, further comprising a second power source coupled to the second axle for driving the second axle to rotate.

3. The 3D/2D display device switching module of claim 2, wherein the first power source and the second power source are step motors, induction motors or servo motors.

4. The 3D/2D display device switching module of claim 1, further comprising a containing box installed on the backside of the display device.

5. The 3D/2D display device switching module of claim 4, wherein the containing box includes at least two symmetric roller modules horizontally installed therein, for stacking and winding the thin film unit between the roller modules.

6. The 3D/2D display device switching module of claim 5, wherein each of the roller modules further includes a tension adjusting structure for adjusting a tension value of the thin film unit when the roller module is rotated in the containing box.

7. The 3D/2D display device switching module of claim 1, wherein the thin film unit includes a plurality of grating areas, and each grating area is arranged in a different way.

8. The 3D/2D display device switching module of claim 7, wherein the thin film unit comprises at least one grating area arranged perpendicularly with respect to the first axle and the second axle.

9. The 3D/2D display device switching module of claim 7, wherein the thin film unit comprises at least one grating area arranged horizontally with respect to the first axle and the second axle.

10. The 3D/2D display device switching module of claim 7, wherein the thin film unit comprises at least one grating area arranged slantingly with respect to the first axle and the second axle.

11. The 3D/2D display device switching module of claim 1, wherein the first power source is a step motor, an induction motor or a servo motor.
